(19) United States
(12) Patent Application Publication
(10) Pub. No.: US 2004/0122818 A1
(43) Pub. Date: Jun. 24, 2004

(54) Method for evaluating processes with a number of characteristic features

(76) Inventors: Robert Hitzelberger, Bobingen (DE); Holger Schrodl, Schwabmuhlhausen (DE)

Correspondence Address: BRINKS HOFER GILSON & LIONE, POST OFFICE BOX 10395, CHICAGO, IL, 60610, US

(21) Appl. No.: 10/351,694

(22) Filed: Jan. 27, 2003

(30) Foreign Application Priority Data
Jul. 27, 2000 (DE) DE 100 36 712.7
Jul. 27, 2001 (WO) PCT/DE01/02880

(51) Int. Cl. G06F 7/00; G06F 17/30

(52) U.S. Cl. 707/5

(57) ABSTRACT

The invention relates to an automated procedure, in particular a computerized procedure for evaluating processes marked by characteristic features in computer-based networked environments. The procedure includes the following steps: establishing a feature tree to represent the set of all features, whereby the features are linked with the weighting assigned to each feature and a functional assigned to each feature to form a process-related feature set; storing the feature trees in a data bank; structuring the range of values of each feature by calculating at least three defined parameters; mapping the individual feature value on a target interval; weighting the mappings by multiplying the individual values of the mappings by the weighting of each feature within the feature tree; evaluating the individual processes by linking the weighted mappings and comparing the additions with each other.

The present invention is a continuation of PCT/DE01/02880 (not published in English), which claims priority to DE 100 36 712.7 filed Jul. 27, 2000, the entire contents of each are hereby incorporated by reference.

### BACKGROUND

The present invention relates to a procedure for evaluating processes and/or transactions marked by characteristic features in computer-based networks.

Today, computer-based networks such as Local Area Networks (LANs), Wide Area Networks (WANs), but also the Internet or the World Wide Web (www) it carries, constitute a platform so important that our economy is unthinkable without it, for controlling production processes and for handling transactions. In particular, more and more transactions between manufacturers, providers and customers are handled via the above named networks and in particular via the Internet.

The worldwide networking of computer systems into a comprehensive communication and control platform has not only advantages but is also fraught with considerable problems. Thus, the flood of information, offers, control parameters, etc. of the kind known so far, presented for example by individual persons or groups authorized to make decisions, but also by conventional expert systems is now hardly calculable, and it is almost impossible to make reasonable choices from among this information overload within a reasonable period of time. It is particularly problematic that only with great difficulty can the data to be compared be reduced to a manageable size if one wishes to ensure that a reasonable selection, manipulation, etc. becomes possible at all. Only through a reduction of the data to be compared is it possible to utilize the available transmission bandwidths and memories of the existing and anticipated networks in a meaningful manner, and without this, the entire infrastructure of computer networks must of necessity collapse sooner or later.

In this vein, a procedure, a computer program and a system for implementing computer-based online trade (e-commerce) has been suggested, for example, in EP 0 845 748, in which a client computer posts a request, and a number of server computers is ready to process this request, whereby the procedure, implemented by an intelligent agent in the form of a computer program, comprises the following steps: receipt of the request from the client computer; evaluation of relevant information and of the terms and conditions of the individual server computers; decision based on relevant information and terms and conditions of the individual server computers pertaining to the question as to which server computer is to process the request.

The problem with the procedures described in the above named document is the fact that the automatic selection and evaluation of transactions is presently done through the utilization of categories. In the evaluation, a default value is entered which sets the goal for realization, but a disadvantage is that similar values are found as well which are close to the default value. This means that the set of results can still be too large.

In another procedure for evaluating processes, called Multivariate Matching, the opposite may happen, namely that no results are obtained at all, and this is just as much of a drawback.

It is therefore the object of the present invention to offer a procedure for evaluating processes marked by characteristic features in computer-based networks, which is capable of bringing a set of features in relation to each other without any existing default values, and which is thus able to filter the most interesting values.

### SUMMARY

The present invention provides for an automated procedure, in particular, a computerized procedure for evaluating processes and/or operations marked by characteristic features in computer-based environments, which according to the invention is characterized in that it comprises the following steps: (a) establishing a feature tree to represent the set of all features, whereby the features are linked with the weighting assigned to each feature and with a functional assigned to each feature to form a process-related feature set; (b) storing the feature trees in a data bank; (c) structuring the range of values of each feature by calculating at least three defined parameters; (d) mapping the individual feature value on a target interval which preferably corresponds to the [0,100] interval; (e) weighting the mappings by multiplying the individual values of the mappings by the weighting of each feature within the feature tree; (f) evaluating the individual processes by means of linking, preferably by adding the weighted mappings, and comparing the linked mappings with each other.

Preferably, the procedure according to the invention is configured such that the weighting represents the valence of the feature in question within the set of all features, whereby the values of the weightings are real numbers in a defined interval and are selected such that the sum of all weightings is constant. Preferably, the values of the weightings are real numbers in the [0,1] interval and are selected such that the sum of all weightings equals 1.

In another embodiment, the procedure according to the present invention can be configured such that the functional of each feature is selected as incrementally continuous, whereby the value range of the functional in question is preferably real in the [0,100] range.

The three parameters for structuring the value range of each feature may be a virtual default value, a minimum value range in question, and a maximum of the value range in question, whereby to determine the virtual default value, preferably the arithmetic mean of all existing values of a feature is formed, which is also preferably mapped to 50 with the assigned functional of the feature. However, the geometric mean, the harmonic mean or another suitable mean can be used as well.

To determine the minimum of the value range of each feature, preferably a virtual minimum is calculated as the measure for the accumulation in the vicinity of the lowest value, whereby the minimum of the value range, which is mapped to 0 by the evaluation functional, is formed by the minimum of the lowest value and the virtual minimum.

It is also preferred to determine the maximum of the value range of each feature by calculating a virtual maximum as the measure for the accumulation of the high values in the vicinity of the highest value, whereby the maximum of the value range, which is mapped by the evaluation functional to 100, is formed by the maximum of the highest value and the virtual maximum.

To calculate the virtual maximums and minimums, the preferred procedure is to deduct the fluctuation of the given values, which describes the relationship between the mean in question and the difference of the given extreme values, from the virtual default value to form the virtual minimum, or to add it to the virtual default value to form the virtual maximum.

To map the individual feature values onto the target interval, which is the value set mapped on [0,100], preferably the value range [minimum, virtual default value] is mapped to the [0,50] interval, and the value range [virtual default value, maximum] is mapped to the [50,100] interval, whereby the two value ranges are mapped via the functional of each feature.

The target interval can be segmented into a part of higher valence and a part of lower valence, whereby the two segments are disjunct. The interval [minimum, virtual default value] is mapped to the part of lower valence, and the interval [virtual default, maximum] is mapped to the part of higher valence.

To weight the mappings of each feature through the functional to the target interval, the preferred procedure is to multiply the individual mappings of each feature by the weighting of that feature within the feature tree.

To evaluate the individual processes, preferably the weighted mappings of the individual features are added through their functional to their target intervals, which defines a metric on the set of the processes and establishes a sequence.

### BRIEF DESCRIPTION OF THE DRAWINGS

Other characteristics and advantages of the invention are explained in the description below of a preferred embodiment, with reference to the drawings, where

FIG. 1 shows a schematic view of a system configuration in which the present invention works in accordance with a preferred embodiment;

FIG. 2 represents a flow chart which shows the steps which are performed in a preferred embodiment of the procedure.

### DESCRIPTION

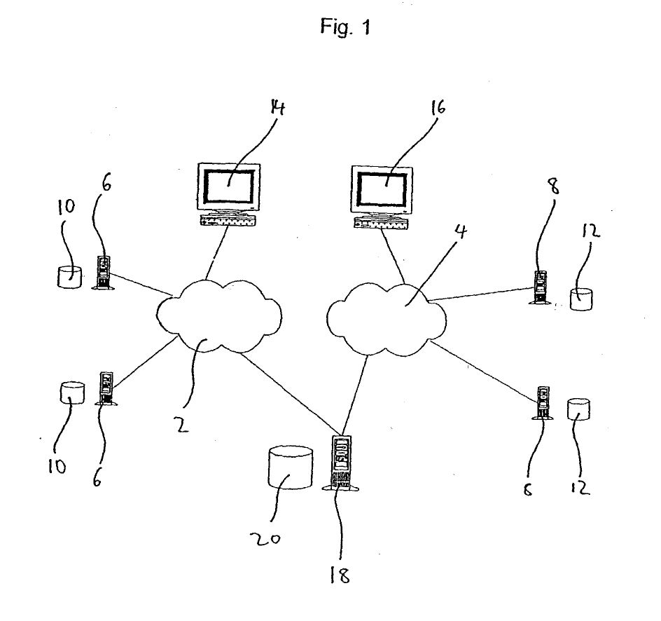

Turning now to the drawings, FIG. 1 shows schematically a system configuration in which the procedure is implemented according to a preferred embodiment of the present invention. FIG. 1 schematically depicts an intranet (2) and the Internet (4) as clouds. In this connection, it is evident that the system configuration is not limited to one intranet (2), but that it can comprise several intranets. Intranet (2) as well as intranet (4) comprises a number of information memories (6, 8), preferably in the form of server computers, each of which is connected with at least one bulk storage (10, 12), e.g. in the form of hard disks, magneto-optic disks, etc. In addition, intranet (2) and the Internet are connected to client computer (14, 16), each of which is equipped with web browsers or other suitable terminal programs for working with the intranet and/or Internet, from which information stored in the information memories (6, 8) or the bulk storage devices (10, 12) can be requested from intranet (2) or the Internet (4). It is obvious that the client computers (14, 16) shown in FIG. 1 are meant to represent a large number of client computers which are connected to intranet (2) or to the Internet (4). Connected to the intranet (2) as well as to the Internet (4) is at least one evaluation computer (18) which communicates with a data base (20). In the configuration shown here, the procedure is implemented preferably in the form of a computer program running on this evaluation computer (18) with data bank (20). The procedure is initiated by a request started by a client computer (14, 16) and implemented with the aid of information stored in the information storage devices (6, 8).

For example, one feasible scenario is where computers with a distributed environment, i.e. computers which may work anywhere in the world, simulate various configurations of a production process, such as a highly complex manufacturing process, with defined peripheral conditions and characteristics. The simulation results, i.e. the suitability of the production structures on which the simulation is based, are compared with each other and evaluated. Under certain circumstances, competing targets such as costs, production time, waste, etc., which affect the result, could be of interest. The procedure according to the invention can be used to select or evaluate the different production systems or structures on which the simulation is based.

In a preferred embodiment, the procedure is initiated by a request made by a client computer (14, 16), stating the process and the characteristic features, and the procedure is implemented in the form of a program or software agent on the evaluation computer (18) in conjunction with the information storage devices (6, 8), which in the presently described scenario could be the computers on which the simulation results are stored.

Initially, according to the procedure, a feature tree is established to represent the set of features or characteristics and the processes to be evaluated, whereby the features are linked to a weighting associated with each feature and a functional assigned to each feature, to form a process-related feature set. Then, the feature tree(s) is/are structured by means of calculating at least three defined parameters. The individual feature values are mapped on a target interval which corresponds to the [0,100] interval, the mappings are weighted by multiplying the individual values of the mappings by the weighting of each feature within the feature tree, and the individual processes are evaluated by adding the weighted mappings and comparing the additions with each other. The output of the results is again performed by the client computer (14, 18) which initiated the procedure.

According to the preferred embodiment, the weighting represents the valence of each feature within the set of all features, whereby the values of the weightings are real numbers in the [0,1] interval and are selected such that the sum of all weightings equals 1.

The functional of each feature is selected as incrementally continuous, whereby the value range of each functional is real in the [0,100] range.

The three parameters for structuring the value range of each feature are a virtual default value, a minimum and a maximum of the value range in question, whereby for determining the virtual default value the arithmetic mean of all existing values of a feature is formed, which is mapped to 50 with the assigned functional of the feature.

To determine the minimum of the value range of each feature, a virtual minimum is calculated as the measure for the accumulation of the low values of each feature in the vicinity of the lowest value, whereby the minimum of the value range, which is mapped to 0 by the evaluation functional, is formed by the minimum of the lowest value and the virtual minimum.

Furthermore, to determine the maximum of the value range of each feature, a virtual maximum is calculated as the measure for the accumulation of the high values of each feature in the vicinity of the highest value, whereby the maximum of the value range, which is mapped to 100 by the evaluation functional, is formed by the maximum of the highest value and the virtual maximum.

To calculate the virtual maximums and minimums, the procedure is to deduct the fluctuation of the given values, which describes the relationship between the mean in question and the difference of the given extreme values, from the virtual default value to form the virtual minimum, or to add the fluctuation of the given values to the virtual default value to form the virtual maximum.

To map the individual feature values onto the target interval, which is the value set mapped on [0,100], the value range [minimum, virtual default value] is mapped to the [0,50] interval, and the value range [virtual default value, maximum] is mapped to the [50,100] interval, whereby the two value ranges are mapped via the functional of each feature.

To weight the mappings of each feature through the functional to the target interval, the procedure is to multiply the individual mappings of each feature by the weighting of that feature within the feature tree.

To evaluate the individual processes, the weighted mappings of the individual features are finally added through their functional to their target intervals, which defines a metric on the set of the processes and establishes a sequence.

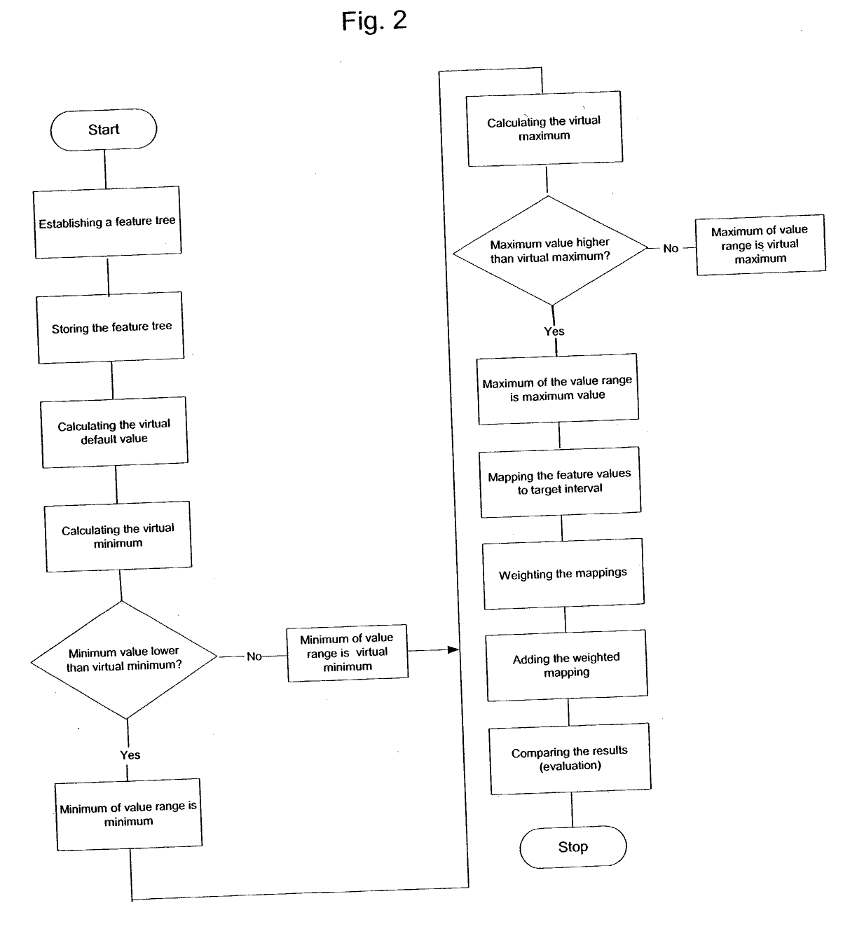

FIG. 2 shows the basic steps followed in the procedure in the form of a flow chart for the procedure according to the present invention.

The procedure according to the present invention achieves the objective, which is to evaluate and select within a reasonable time frame almost any number of different offered and/or available alternatives of certain processes, operations, etc., which are encountered in networked environments such as the Internet, and which against the background of certain features and peripheral conditions are the most interesting or advantageous.

With the automated selection and evaluation in accordance with the present invention, there is no necessity—in basic contrast with procedures known from prior art—to work with a default value that specifies the goal to be achieved, and this means that the number of results can be kept within a manageable range. In this manner, the efficiency can be increased to a previously unheard of extent in terms of time as well as in terms of band widths and storage capacities for selection processes.

1. A computerized procedure for evaluating processes marked by characteristic features in computer-based, networked environments, comprising:
a. establishing at least one feature tree to represent a set of all features, whereby the features are linked with a weighting assigned to each feature and with a functional assigned to each feature to form a process-related feature set;
b. storing the at least one feature tree in a data bank;
c. structuring a range of values of each feature by calculating at least three defined parameters;
d. mapping on individual feature value on a target interval;
e. weighting the mappings by multiplying individual values of the mappings by the weighting of each feature within the feature tree; and,
f. evaluating the individual processes by means of linking the weighted mappings and comparing the linked mappings with each other.

2. The procedure according to claim 1 wherein the means of linking the weighted mappings includes adding the weighted mappings.

3. The procedure according to claim 1 wherein the weighting represents a valence of each feature within the process-related feature set.

4. The procedure according to claim 1 wherein the weightings have values that are real numbers in a defined interval and are selected such that the sum of all weightings is constant.

5. The procedure according to claim 4 wherein the weightings have values that are real numbers in a [0,1] interval and are selected such that the sum of all weightings is 1.

6. The procedure according to claim 1 wherein the target interval corresponds to a [0,100] interval.

7. The procedure according to claim 1 wherein the functional of each feature is selected as incrementally continuous.

8. The procedure according to claim 7 wherein each functional has a value that is real in a [0,100] range.

9. The procedure according to claim 1 wherein the at least three defined parameters for structuring the range of values of each feature include a virtual default value, a minimum of the value range, and a maximum of the value range.

10. The procedure according to claim 9 wherein to determine the virtual default value from among all existing values of a feature, a geometric mean is formed, which is mapped to 50 with the associated functional.

11. The procedure according to claim 9 wherein to determine the virtual default value from among all existing values of a feature, a harmonic mean is formed, which is mapped to 50 with the associated functional.

12. The procedure according to claim 9 wherein to determine the virtual default value from among all existing values of a feature, an arithmetic mean is formed, which is mapped to 50 with the associated functional.

13. The procedure according to claim 9 wherein to determine the virtual default value, a median of all existing values of a feature is formed which is mapped to 50 with the associated functional.

14. The procedure according to claim 9 wherein to determine the minimum of the value range of each feature, a virtual minimum is calculated as a measure of the accumulation of the low values of the feature in question in the vicinity of the smallest value, whereby the minimum of the value range, which is mapped by the evaluation functional to the lower limit of the target interval, is formed by the minimum of the lowest value and the virtual minimum.

15. The procedure according to claim 14 wherein to determine the maximum of the value range of each feature, a virtual maximum is calculated as a measure of the accumulation of the high values of the feature in question in the vicinity of the highest value, whereby the maximum of the value range, which is mapped by the evaluation functional to the upper limit of the target interval, is formed by the maximum of the highest value and the virtual maximum.

16. The procedure according to claim 15 wherein to calculate the virtual minimum, a fluctuation of the given values is deducted from the virtual default value to form the virtual minimum, and to calculate the virtual maximum, a fluctuation of the given values is added to the virtual default value to form the virtual maximum.

17. The procedure according to claim 15 wherein to map the individual feature values to the target interval, the value range [minimum, virtual default value] is mapped to a [0,50] interval, and the value range [virtual default value, maximum] is mapped to a [50,100] interval, whereby the two value ranges are mapped via the functional of each feature.

18. The procedure according to claim 15 wherein to map the individual feature values to the target interval, the target interval is segmented into a part of higher valence and a part of lower valence, whereby the two segments are disjunct, and an interval [minimum, virtual default value] is mapped to the part of lower valence, and an interval [virtual default, maximum] is mapped to the part of higher valence.

19. The procedure according to claim 1 wherein to weight the mappings of the feature through the associated functional of the feature to the target interval, individual results of the functional of the feature in question are multiplied by the weighting of the individual feature within the feature tree.

20. The procedure according to claim 1 wherein to evaluate the individual processes, the weighted mappings of the individual features are added through their functional to its target interval, which defines a metric on the set of the processes and establishes a sequence.
